(19) United States
(12) Patent Application Publication
(10) Pub. No.: US 2020/0170085 A1
(43) Pub. Date: May 28, 2020

(54) WIRELESS SHELF LIGHTING SYSTEM ADAPTED TO COMMUNICATE WITH A DEVICE TO SELECT ONE OR MORE SECTIONS OF THE LIGHT TRACK

(71) Applicant: Jean-Claude Louis Detre, Oviedo, FL (US)

(72) Inventor: Jean-Claude Louis Detre, Oviedo, FL (US)

(21) Appl. No.: 16/454,454

(22) Filed: Jun. 27, 2019

Related U.S. Application Data
(60) Provisional application No. 62/771,268, filed on Nov. 26, 2018.

(51) Int. Cl. H05B 37/02; G08B 5/36; B65G 1/137

(52) U.S. Cl. CPC H05B 37/0272; G06Q 10/087; B65G 1/137; G08B 5/36

(57) ABSTRACT

A selective shelf lighting system is provided. The shelf lighting system is adapted so that portions of the shelving may be selectively powered via a wireless computing device based on inventory associated with those portions, wherein the desired inventory may be identified by the wireless computing device is provided. The shelf lighting system is enabled so that one or more portions of light tracks connected to the shelving are powered so as to specifically identify a relevant portion of the shelf associated with an inventory item a user inputs into the wireless computing device. A systemic software application can associate each portion of the light track(s) with a predetermined inventory item so that a user of the wireless computing device, such as a customer or a stockperson, can identify the relevant location of possibly a vast array of shelves within a large storage space.

### CROSS-REFERENCE TO RELATED APPLICATION

This application claims the benefit of priority of U.S. provisional application number 62/771,268, filed 26 Nov. 2018, the contents of which are herein incorporated by reference.

### BACKGROUND OF THE INVENTION

The present invention relates to lighting systems and, more particularly, a shelf lighting system adapted to selectively identify relevant portions of a shelf for loading thereon and/or unloading items therefrom. The identification is signaled via selectively powering one or more sections of a light track associated with said shelf, wherein such communication is powered via a wireless device.

When attempting to locate something on a large shelf, possibly one shelf of a plurality of shelves against a plurality of walls, assistance pinpointing the specific, relevant location along the shelf or shelves would be a boon, especially if visibility of the contents of the shelf is limited because of its location above the ground.

Current shelf lighting systems are not capable of selectively lighting a portion of a much longer track of lighting, and thus they lack the ability to identify a specific location with any accuracy. Rather, most of the current shelf lighting systems are hard wired and use “full shelf” one-piece track lighting that illuminates light over the entirety of the shelf or shelves. In short, current shelf lighting systems are either on or off for a full section, and so the wiring and/or the remote connection would need to be modified in store to provide any greater specificity.

As can be seen, there is a need for a shelf lighting system adapted to selectively power via a wireless device one or more portions of the light track so as to specifically identify a relevant portion of the shelf associated with an item a user inputs into said wireless device needed during a store visit. Thus, the selective shelf lighting system is enabled to light up a specific product on a store shelving or a portion of store shelving from a software that recognizes the location of the product and then sends the activation command to only a portion of the track to light the specified product associated with that portion or strip of the track of light. The present invention enables a user to pinpoint a specified product by enabling the track to turn off any lights not situated with the specific product. Additionally, user could include those stocking the shelves in the first place.

### SUMMARY OF THE INVENTION

In one aspect of the present invention, a shelf lighting system includes the following: a plurality of lighting strips; each lighting strip electrically powered via a lighting control unit; each lighting control unit associated with one or more inventory items through a software application accessible by a computing device; and the computing device configured by the software application to prompt a user for a selection of said one or more inventory items, wherein associated lighting control units are powered based on an operative association between said selection and one or more lighting strips of the plurality of lighting strips.

In another aspect of the present invention, the shelf lighting system further includes the following: a physical connection of each lighting strip along one or more shelving units supporting the associated one or more inventory items; a flange provided along each shelf unit, wherein each lighting strip is physically connected adjacent to said flange, wherein each physical connection is disposed along an underneath portion of the one or more shelving units; a diffusing cover operatively associated with each lighting strip, and wherein each lighting strip provides a plurality of lighting elements, and wherein each plurality of lighting elements includes a plurality of colors, so that each selection of a plurality of the selection powers a different color of the plurality of colors, whereby distinguishing multiple users/selections.

These and other features, aspects and advantages of the present invention will become better understood with reference to the following drawings, description and claims.

### BRIEF DESCRIPTION OF THE DRAWINGS

FIG. 1 is a lower perspective view of an exemplary embodiment of the present invention;

FIG. 2 is an exploded view of an exemplary embodiment of the present invention;

FIG. 3 is a section view of an exemplary embodiment of the present invention, taken along line 3-3 of FIG. 1; and

FIG. 4 is a schematic view of an exemplary embodiment of the present invention, with the magnetic backing 12 and diffusing light cover 16 removed for clarity.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a shelf lighting system adapted to selectively power via a wireless computing device one or more portions of the light track(s) so as to specifically identify a relevant portion of the shelf associated with an item a user inputs into the wireless computing device. A software application operatively associated with the wireless computing device can associate each portion of the light track(s) with a predetermined item so that a user of the wireless computing device, such as a customer or a stockperson, can identify the relevant location of possibly a vast array of shelves within a large storage space.

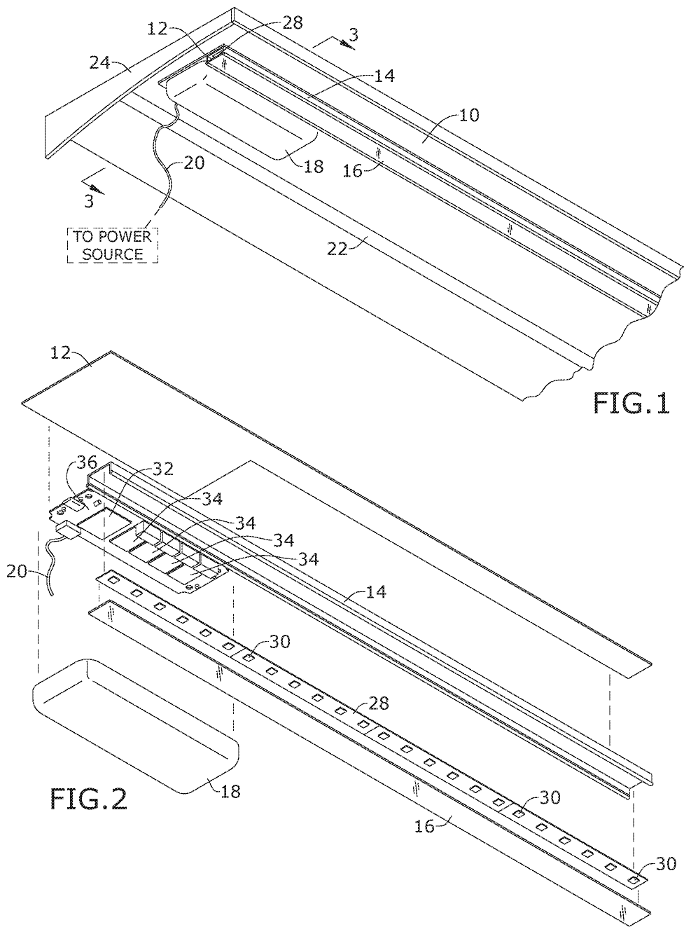

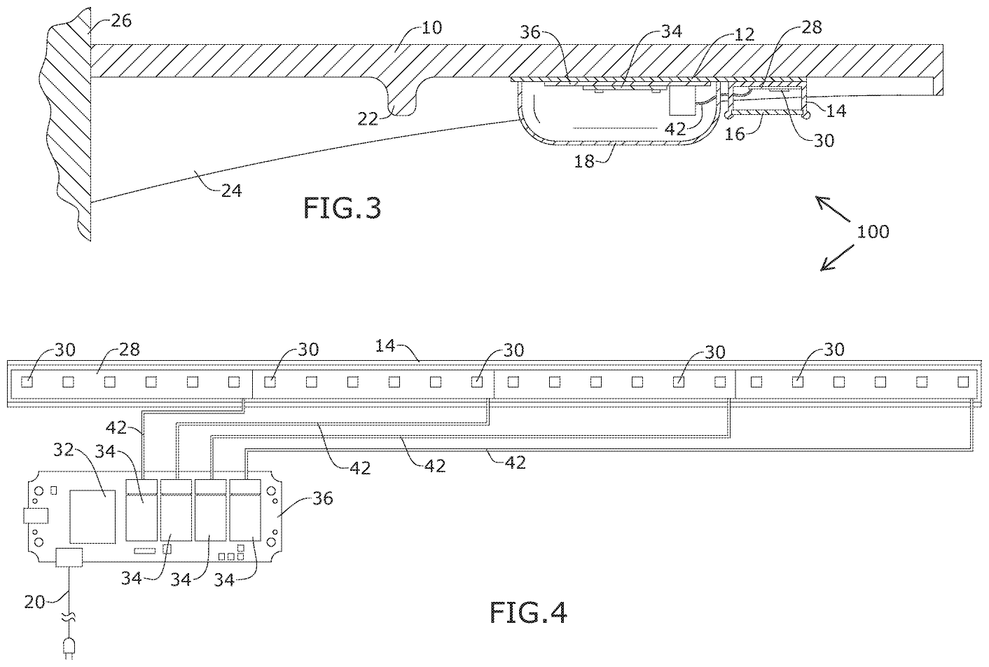

Referring now to FIGS. 1 through 4, the present invention may include a selective shelf lighting system 100 adapted to wirelessly power selected portions of a myriad of portions via a remote computer. The selective shelf lighting system 100 may include at least one computer. The computer may include at least one processing unit coupled to a form of memory. The computer may include, but not limited to, a microprocessor, a control circuitry, a server, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The selective shelf lighting system 100 may include a plurality of lighting strips 28 associated with a much longer track of lighting. Each lighting strip 28 proving a plurality of output devices 30, such as LEDs or other light-emitting output devices. Each lighting strip 28 may be electrically connected 42 to a control circuitry 32 and 36, which is electrically connected 20 to a power source. The control circuitry 32 and 36 may include a wireless/Bluetooth® transmitter, a relay board, a microprocessor and the like. Each lighting strip 28 may be operatively associated with a lighting control unit/microprocessor 34 for powering one or more lighting strip 28 of a plurality of lighting strips 28.

In certain embodiments, each lighting strip 28 may have multiple “channels” (for example 16 channels), wherein and each channel can be activated individually or collectively. In some embodiments, each lighting strip 28 provides a plurality of lighting elements, and wherein each plurality of lighting elements includes a plurality of colors so that different users or selections may only power different colors of the plurality of colors so as to distinguish multiple users/selections.

Each lighting strip 28 may be physically associated with a preselected portion of a shelf unit 10 of a plurality of shelf units 10. Each shelf unit 10 may be attached to a supporting surface 26, such as a wall, with the assistance of a shelf bracket 24. The shelf unit 10 may include a flange 22 to provide structural support to the shelf unit 10.

A connector 12, such as an adhesive or magnetic material, may connect each lighting strip 28 to an associated portion of a shelf unit 10, for example to the underside of the shelf unit 10 or along the supporting surface 26 adjacent to the shelf unit 10. In certain embodiments, a channel bracket 14 with a translucent, transparent, or diffusing cover 16 may provide an enclosure for housing the lighting strip 28. Whereby, the channel bracket 14 is attached via the connector 12 to the shelf unit 10. Also, in some embodiments, the associated control circuitry 32/26 may be connected via the same connector 12. In such embodiments, a housing 18 may enclose the associated control circuitry 32/26. In some embodiment, each channel bracket 14, with the above mentioned “channel” of lighting.

The associated control circuitry 32/26—through the loaded software—may be configured to wirelessly (for example, by way of Bluetooth® or related wireless communication) communicate with a host computer. The host computer can selectively associate each lighting control unit/microprocessor 34 with one or more data sets. Each data set may include items associated with the portion of the shelf unit 10 associated with a lighting strip 28.

Similarly, the control circuitry 32/26 may wirelessly communicate with a plurality of user computing devices so that predetermined users (customers) can selectively input one or more items, and if each item is associated with a data set operatively associated with a lighting control unit/microprocessor 34, that respective lighting strip 28 lights up, directing the customer to the appropriate shelf unit 10 so that they can easily find the selected items. Also, through the software, the host computer is able to remotely modify the selection if a product is changed or is relocated, removing the need to send a crew in store to adjust the lighting selection.

In certain embodiments, the software application operatively associated with the wireless computing device can associate each portion of the light track(s) with a predetermined item so that a user of the wireless computing device, such as a customer or a stockperson, can identify the relevant location of possibly a vast array of shelves within a large storage space. Whereby said software application can be downloaded to or accessed by customer's smart devices as they enter a store or other facility with vast arrays of shelving. Thereby, the customers can quickly locate those items. Likewise, would-be customers may be able to access the software application remotely (for example from their homes) so they can see if desired items/inventory is in stock via the user interface of their smart device.

Bluetooth® or wifi or RJ45 connections allow to connect only seven simultaneously Bluetooth® wifi or RJ45 connections, the software of the present invention is configured to bypass this, and so allow multiple connections through sending commands to a specific lighting control unit/microprocessor 34 for each lighting strip 28.

Additionally, the present invention may be used outside the context of shelving units, and could be used to light up a specific display or specific Internet of Things (IOT) components.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A shelf lighting system, comprising:
a plurality of lighting strips;
each lighting strip electrically powered via a lighting control unit;
each lighting control unit associated with one or more inventory items through a software application accessible by a computing device; and
the computing device configured by the software application to prompt a user for a selection of said one or more inventory items, wherein associated lighting control units are powered based on an operative association between said selection and one or more lighting strips of the plurality of lighting strips.

2. The shelf lighting system of claim 1, further comprising a physical connection of each lighting strip along one or more shelving units supporting the associated one or more inventory items.

3. The shelf lighting system of claim 2, further comprising a flange provided along each shelf unit, wherein each lighting strip is physically connected adjacent to said flange.

4. The shelf lighting system of claim 2, wherein each physical connection is disposed along an underneath portion of the one or more shelving units.

5. The shelf lighting system of claim 2, further comprising a diffusing cover operatively associated with each lighting strip.

6. The shelf lighting system of claim 1, wherein each lighting strip provides a plurality of lighting elements, and wherein each plurality of lighting elements includes a plurality of colors, so that each selection of a plurality of the selection powers a different color of the plurality of colors, whereby distinguishing multiple users/selections.
